(19) United States
(12) Patent Application Publication
(10) Pub. No.: US 2025/0162078 A1
(43) Pub. Date: May 22, 2025

(54) Method for Closing a Round Battery Cell, and Round Battery Cell

(71) Applicant: Bayerische Motoren Werke Aktiengesellschaft, Muenchen (DE)

(72) Inventors: Niclas EMRICH, Muenchen (DE); Christoph PILLER, Herrsching (DE)

(21) Appl. No.: 18/839,904

(22) PCT Filed: Mar. 15, 2023
(86) PCT No.: PCT/EP2023/056576

§ 371 Date: Aug. 20, 2024

(30) Foreign Application Priority Data
Apr. 5, 2022 (DE) 10 2022 108 143.5

(51) Int. Cl. B23K 26/352; G01J 1/42; H01M 50/171

(52) U.S. Cl. CPC B23K 26/352; G01J 1/42; H01M 50/171; G01J 2001/4238

(57) ABSTRACT

A method for pretreating a surface of a workpiece includes radiating an energy beam onto the surface to pretreat the surface; capturing electromagnetic radiation of the energy beam by a capture device, the capture device providing at least one electrical signal characterizing the captured electromagnetic radiation; and monitoring the at least one electrical signal.

### BACKGROUND AND SUMMARY

The present disclosure relates to a method for sealing a round battery cell according to the preamble of claim 1. Moreover, the present disclosure relates to a round battery cell according to claim 8.

Round battery cells have numerous possible applications and are also used in particular in traction batteries for motor vehicles. When used in traction batteries and thus for electromobility, it is desirable for the volumetric energy density of the individual round battery cell to be particularly high.

According to the art, round battery cells (in short: round cells) are sealed by crimping, which is a joining process in which two components, for example battery housing and cover, are joined together by plastic deformation. During crimping, for example, beads, crimps, ripples and/or folds are formed. DE 10 2013 021 203 A1 shows a single cell for a battery.

The disadvantage of crimping is that, for example, additional installation space and/or housing material is required for crimping the housing parts. The electrical contact is made with separate contact elements that exist in addition to a cover plate, which has a negative overall effect on the volumetric energy density of the round cell.

An object of the present disclosure is therefore to provide a method for sealing a round battery cell and a round battery cell, by which it is possible in a particularly advantageous manner to design the volumetric energy density of the round battery cell to be particularly high.

This object is achieved, according to the present disclosure, by the subjects of the present disclosure. Advantageous embodiments and developments are further given in the present disclosure as well as in in the drawings.

A first aspect of the present disclosure relates to a method for sealing a round battery cell. The round battery cell comprises an essentially cylindrical housing which is sealed at one end by a base having a connection element and has an opening at another end. The housing material is a sheet metal, for example, which may have a coating, and corresponds in shape to a barrel-shaped sleeve having a base. The base can be formed in one piece with the cylindrical outer surface of the housing. The connection element is in particular a contact for a cathode element of the round battery cell and is used for contacting and is therefore in particular designed in such a manner that it passes through the base or is arranged in an in particular centered opening of the base. “Essentially cylindrical” means that slight deviations from a circular base surface, which the base in particular has, are possible, it is thus possible, for example, to achieve a slightly elliptical shape.

The method according to the present disclosure comprises multiple steps so that the round battery cell can be sealed in a particularly advantageous manner, so that, for example, installation space can be saved in an advantageous manner. In a first step, a contacting plate is arranged transversely to a rolling direction at one end of a rolling element, which is rolled from a separator element, a cathode element and an anode element and on which a contact element is arranged and/or fastened at another end. In particular, the contact element is connected to the cathode element.

The contacting plate is essentially round or circular, wherein a diameter, in particular the outer diameter, of the contacting plate essentially corresponds to a diameter, the inner and/or outer diameter, of the cylindrical housing. The rolling element is known as a Swiss roll or in English jelly roll, since its cross-section is reminiscent of a Swiss roll. In the case of the rolling element, an insulating film, a thin layer of anode material, a separator layer and a cathode material are usually layered and rolled in order to be subsequently inserted into a cylindrical housing, particularly a hollow one, such as the housing. The rolling element is particularly suitable for use in rechargeable batteries.

In a second step of the method, the contacting plate is melted or welded to the anode element of the rolling element via at least one welding point. During the welding process, the contacting plate, which was previously arranged in particular in a flat manner transversely to the rolling direction, is fixed to the rolling element.

In a third step, the rolling element is inserted with the contact element leading through the opening into the housing. This brings the contact element into contact with the connection element, in particular to establish electrical contact between the contact element and the connection element and thus between the cathode element and the connection element, and the contacting plate comes into contact with the housing at a housing edge or housing area adjacent to the opening. The contact element is arranged at the end of the rolling element opposite the contacting plate. The housing edge or the housing area can be arranged on an upper side of the housing, in other words, on the side of the housing opposite the base and/or on an inner side of the housing.

In a fourth step, the contacting plate is welded to the housing, in particular circumferentially round the housing area or in particular where the contact between the contacting plate and the housing is formed. In a fifth step, a cover is arranged on the contacting plate. Finally, in a sixth step, the cover is welded to the housing and/or the contacting plate.

In other words, in the case of the method, the round contacting plate is connected to the rolling element, which has the contact element at the end-face side at one end, and is connected at another end to the anode element, in particular in a flat manner and by welding via at least one welding point. The rolling element is then inserted into the housing with the contact element leading through the opening, whereby the contact element comes into contact with the connection element and the contacting plate comes into contact with the housing at a housing edge or housing area adjacent to the opening. A weld seam is drawn along the housing edge or where the contacting plate makes contact with the housing. A cover is then placed on the contacting plate and welded to the housing and/or the contacting plate.

In particular, the contacting plate is designed in such a manner that it can assume part of the cover or a cover plate and thus the functions of the cover. In particular, the contacting plate is made of copper and is welded onto the so-called copper side of the jelly roll, in particular by laser welding.

The advantage of the method according to the present disclosure is that the battery cell can be sealed in a particularly advantageous manner, which means that it can be designed with a particularly high energy density. A further advantage of the method according to the present disclosure is that superfluous installation space and/or housing material can be saved.

In an advantageous embodiment of the present disclosure, the welding is carried out by laser welding or the welding is laser welding. Laser welding or laser beam welding is a welding process in which the energy for melting the components to be welded (for example the housing) is supplied via a laser beam. It is particularly suitable for fast welding or for high welding speeds. It is also suitable for forming narrow and/or slim weld seams, which makes it particularly advantageous for sealing the round battery cell.

In a further advantageous embodiment of the present disclosure, the contacting plate is welded to the housing and the cover is welded to the housing and/or the contacting plate at the same time. In other words, the welding of the cover assembly (contacting plate, cover) to the housing takes place in a single operation. This has the advantage that the method can be carried out particularly efficiently. A further advantage is that the method can be carried out particularly quickly.

In a further advantageous embodiment of the present disclosure, an outer diameter of the cover is smaller than an outer diameter of the contacting plate and the cover is welded to the contacting plate, in particular circumferentially. In particular, the cover and the contacting plate are centered in relation to each other so that their centers overlap. As a result, the contacting plate, when welded to the housing, protrudes from underneath the cover. This results in the advantage that the round battery cell can be designed with particularly little installation space, which means that the energy density is particularly high.

In a further advantageous embodiment of the present disclosure, the cover has a cylindrical casing element on the circumference side, which is placed over the housing on the side of the opening and welded to it, in particular circumferentially. In other words, the cover itself is designed as a cylinder, wherein its inner diameter is greater than or equal to the outer diameter of the housing and its height or longitudinal extension direction is significantly shorter than that of the housing. This results in the advantage that the round cell can be sealed by the housing due to the overlap of the cylindrical casing element in such a manner that the round battery cell is particularly mechanically resilient.

In a further advantageous embodiment of the present disclosure, the contacting plate has an area of increased material density on the outer circumference side, which is melted during welding in such a manner that both the cover and the housing are welded to this area. In other words, a particularly ring-shaped area is provided, which is arranged on the outside of the contacting plate and is used for welding. This material area thus fulfills the function of a welding filler material, so to speak. The material thickness of the contacting plate is selected so that the weld metal, in other words, the contacting plate and/or the housing for welding, does not require any extra welding filler material. This has the advantage that a weld seam can be formed in a particularly advantageous manner. Another advantage is that the sealing can be carried out in a particularly installation space-saving manner, since three weld items can be brought together with one weld seam.

In a further advantageous embodiment of the present disclosure, the contacting plate has an area of increased material thickness on the outer circumference side, which is melted in such a manner that the cover is welded to the housing through the area. In other words, the contacting plate is not welded directly to the housing; instead, it is welded through the cover to the contacting plate and the cover itself is welded to the housing. This has the advantage that the round battery cell can be sealed in a particularly advantageous manner.

A second aspect of the present disclosure relates to a round battery cell having an essentially cylindrical housing, which is sealed at one end by a base having a connection element and wherein a contacting plate is arranged at another end. A rolling element is arranged in the housing and the rolling element is rolled from a separator element, a cathode element and an anode element. The round battery cell is advantageously sealed by a method according to the first aspect of the present disclosure.

Advantages and advantageous embodiments of the first aspect of the present disclosure are to be regarded as advantages and an advantageous embodiment of the second aspect of the present disclosure and vice versa.

In an advantageous embodiment of the present disclosure, the contacting plate has at least one cut-out through which fluid can pass. In other words, the contacting plate has at least one opening through which gas and/or electrolyte can pass. For the sake of completeness, it is mentioned here that the round battery cell is generally filled with an electrolyte before final sealing, which is present in particular in the fluid aggregate state under normal conditions or standard conditions. This results in the advantage that the contacting plate can establish contact with the anode element in a particularly advantageous manner and at the same time can be arranged in a particularly fail-safe manner.

In a further advantageous embodiment of the present disclosure, the contacting plate has at least two areas of different material thicknesses, wherein each of the areas is welded to another component of the round battery cell. In other words, for example, there is a thick area of the contacting plate and a thin area of the contacting plate, wherein the thin area is welded to the anode element, for example, and the thick area being welded to the housing. This has the advantage that the amount of material required to form the respective weld seam can be provided by the contacting plate in a particularly advantageous manner without having to use welding filler material. The round battery cell can thus be formed in a particularly shape-efficient manner.

Further features of the present disclosure can be seen from the figures and the description of the figures. The features and combinations of features mentioned above in the description as well as the features and combinations of features mentioned below in the description of the figures and/or shown alone in the figures can be used not only in the combination indicated in each case, but also in other combinations or on their own.

The present disclosure will now be explained in more detail with reference to a preferred exemplary embodiment and with reference to the drawings.

### BRIEF DESCRIPTION OF THE DRAWINGS

FIG. 1 shows a schematic top view of a contacting plate, which is designed for sealing a round battery cell;

FIG. 2 shows a schematic sectional view through the round battery cell with the contacting plate according to FIG. 1;

FIG. 3 shows a schematic sectional view through the round battery cell with a first embodiment of a cover for sealing the round battery cell;

FIG. 4 shows a schematic sectional view through the round battery cell with a second embodiment of the cover for sealing the round battery cell;

FIG. 5 shows schematic sectional views through the round battery cell with a second embodiment of the contacting plate before and after welding with a third embodiment of the cover; and

FIG. 6 shows a schematic sectional view through the round battery cell with a second embodiment of the cover for sealing the round battery cell.

### DETAILED DESCRIPTION OF THE DRAWINGS

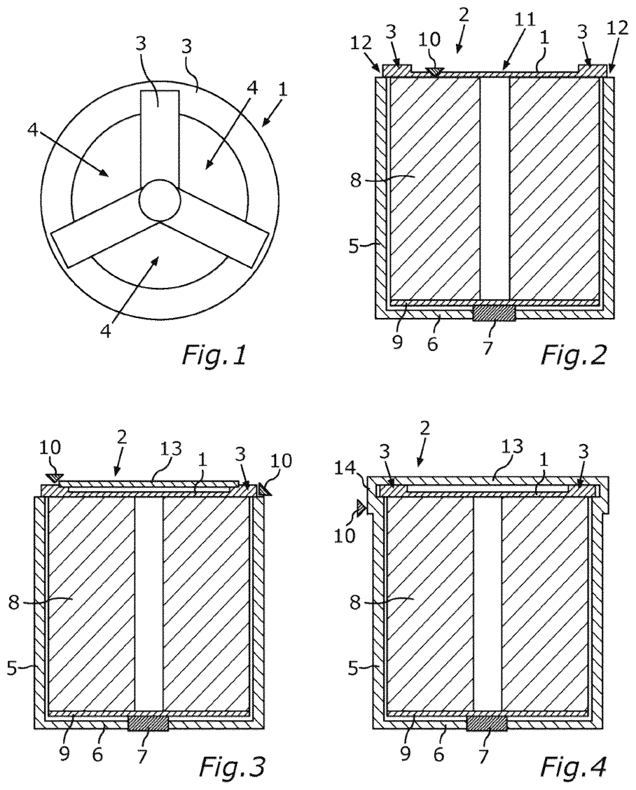

FIG. 1 shows a schematic top view of a contacting plate 1 made of copper, for example, which is used to seal a round battery cell 2 and thus in the case of a method for sealing the round battery cell 2. The figures are intended to illustrate this method, which is particularly advantageous for closing or sealing the round battery cell 2. With the method, the round battery cell 2 can, for example, be designed with a particularly small installation space and thus with a particularly high volumetric energy density.

For this purpose, it can be advantageous if the contacting plate 1 has different areas 3, each of which has a different material thickness. Furthermore, the contacting plate can have at least one cut-out 4 through which fluid can pass.

FIG. 2 shows a schematic sectional view of the round battery cell 2 in an unsealed state, comprising a housing 5 having a base 6, on which a connection element 7 is arranged and the base 6 seals the housing 5, which is in particular cylindrical, at one end.

The method for sealing the round battery cell 2 comprises multiple steps:

In a first step, the essentially round contacting plate 1 is arranged transversely to the rolling direction at one end of a rolling element 8, which is rolled from a separator element, a cathode element and an anode element. A contact element 9, which is connected in particular to the cathode element of the rolling element 8, is arranged at the other end of the rolling element 8.

In a second step, the contacting plate 1 is welded to the anode element of the rolling element 8 via at least one welding point, shown by a welding point marking 10.

The schematic sectional view of FIG. 2 shows a third step of the method, in which the rolling element 8 is inserted with the contact element 9 leading through an opening 11 into the housing 5, whereby the contact element 9 comes into contact with the connection element 7 and the contacting plate 1 comes into contact with the housing 5 at a housing edge or housing area 12 adjacent to the opening 11. When the contact element 9 comes into contact with the connection element 7, the positive pole of the round battery cell 2 is provided, so to speak. At least part of the contacting plate 1 provides the negative pole of the round battery cell 2 by welding it to the anode element.

Further steps, steps 4 to 6, of the method for sealing the round battery cell 2 are now described with reference to the schematic sectional view in FIG. 3. In the fourth step, the contacting plate 1 is welded to the housing 5, in particular circumferentially, along the housing edge or the housing area 12 and thus where the contact between the contacting plate 1 and the housing has been created by the insertion of the rolling element 8 into the housing 5.

The welding is also shown by a welding point marking 10. In the fifth step, a cover 13 is now arranged on the contacting plate 1. Finally, in a sixth step, the cover 13 is welded to the housing 5 and/or the contacting plate 1, wherein this is also shown by a welding point marking 10. The cover 13 becomes twisted, particularly in the event that a weld seam between the contacting plate 1 and housing 5 is not completely sealed.

As FIG. 3 shows, the cover 13 is welded inside the contacting plate 1 so that an outer diameter of the cover 13 is smaller than an outer diameter of the contacting plate 1. The cover 13 is welded to the contacting plate 1 in order to seal the round battery cell 2.

FIG. 4 shows a schematic sectional view of the round battery cell 2 with a further embodiment of the cover 13. Here, the cover 13 is designed so that it is placed over the housing 5 and completely covers the contacting plate 1. The cover 13 is welded directly to the side of the housing 5, as shown by the welding point marking 10. The cover 13 which has a cylindrical casing element 14 on the circumference side is welded thereto at the housing 5 after it has been placed over the latter.

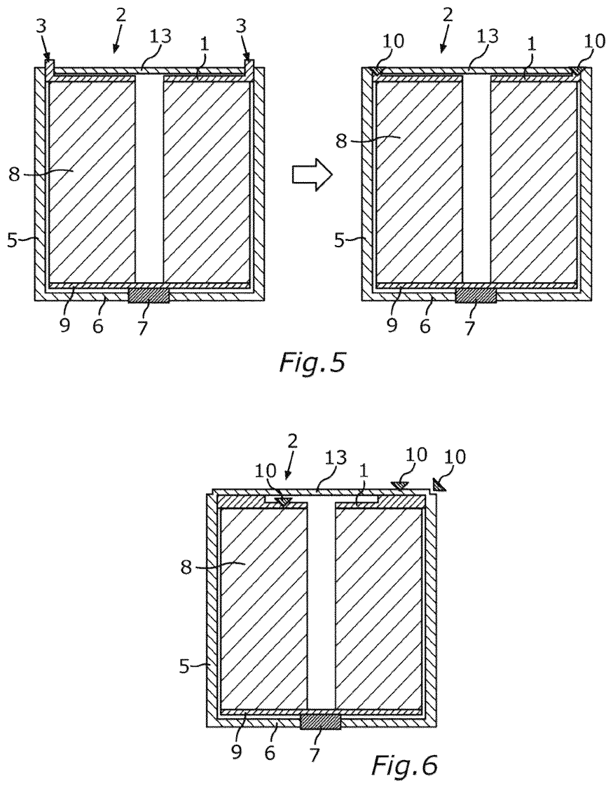

The difference between the left and right round battery cells 2 shown in FIG. 5 is the state of welding. Thus, the left-hand round battery cell 2 shows the cover 13 not welded and the right-hand round battery cell 2 shows the cover 13 welded. In the embodiment shown in FIG. 5, the contacting plate 1, which has an increased material thickness on the outer circumferential area 3, is melted for welding in such a manner that both the cover 13 and the housing 5 are connected to this area 3. In this embodiment, it is particularly suitable that the welding of the contacting plate 1 to the housing 5 and the welding of the cover 13 to the housing 5 and/or the contacting plate 1 take place together or at the same time. The respective welding is advantageously carried out as laser welding.

Finally, FIG. 6 also shows a schematic sectional view of a raised outer circumferential area 3 of the contacting plate 1, which is melted in such a manner that the cover 13 is welded to the housing 5 through the area 3. In other words, the contacting plate 1 is not welded to the housing 5, at least not initially, instead, the cover 13 is welded through to the contacting plate 1 and the cover 13 itself is welded to the housing 5 (via the contacting plate 1), whereby, for example, the round battery cell 2 can be closed in a particularly advantageous manner.

The method shown with the various designs of the cover 13 makes it possible to seal the round battery cell 2, wherein the contacting plate 1 also assumes parts of the function of the cover 13 itself and thus sealing in a particularly installation space-saving and/or housing material-saving manner is possible.

The contacting plate 1 has areas 3 of different material thicknesses that are optimized for the respective welding processes. In addition, the contacting plate 1 can have cut-outs 4 to enable gas and electrolyte to pass through. In summary, the method shows: the rolling element 8, in English jelly roll, is inserted into the housing 5 so that the contacting plate 1 comes to rest on the housing edge 5. This contact surface is provided with an in particular circumferential, tight laser-welded seam. Since the weld seam between the contacting plate 1 and the rolling element 8 can presumably not always be made gas-tight, the cover 13 is provided.

In the variant shown in FIG. 3, welding takes place inside the contacting plate 1. In the variant shown in FIG. 4, the cover 13 is placed over the housing 5 and the contacting plate 1 is completely covered by the cover 13. In the variant shown in FIG. 5, the cover assembly or housing 5 and contacting plate are welded in a single operation so that particularly few weld seams are provided. In the variants shown in FIG. 6, the contacting plate 1 is melted by welding through the cover 13.

The shown embodiments of the method for sealing the round cell can save installation space in a particularly advantageous manner and thus achieve a particularly high volumetric energy density of the round battery cell 2.

### LIST OF REFERENCE SYMBOLS

1 Contacting plate
2 Round battery cell
3 Area
4 Cut-out
5 Housing
6 Base
7 Connection element
8 Round element
9 Contact element
10 Welding point marking
11 Opening
12 Housing area
13 Cover
14 Casing element

1-10. (canceled)

11. A method for pretreating a surface of a workpiece for joining following the pretreating, the method comprising:
radiating an energy beam onto the surface to pretreat the surface;
capturing electromagnetic radiation of the energy beam by a capture device, the capture device providing at least one electrical signal characterizing the captured electromagnetic radiation; and
monitoring, by an evaluation device, the pretreating based on the at least one electrical signal.

12. The method according to claim 11, comprising:
comparing, by the evaluation device, an actual signal with a target signal, the actual signal comprising the electrical signal or at least one evaluation signal generated from the electrical signal; and
monitoring the pretreating based on the comparing.

13. The method according to claim 12, comprising:
outputting at least one haptically and/or optically and/or acoustically perceptible warning signal by a playback device in response to a deviation of the actual signal from the target signal exceeding a threshold value.

14. The method according to claim 11, wherein a frequency at which the electromagnetic radiation is captured by the capture device and at least temporarily stored is at least 10 kHz.

15. The method according to claim 11, comprising:
radiating the energy beam onto the surface in a pulsed manner.

16. The method according to claim 15, comprising:
radiating the energy beam onto the surface in a pulsed manner at a frequency of at least 1 kHz.

17. The method according to claim 11, comprising:
capturing the electromagnetic radiation by a first sensor of the capture device in a first wavelength range; and
capturing the electromagnetic radiation by a second sensor of the capture device in a second wavelength range that at least partially differs from the first wavelength range.

18. The method according to claim 11, wherein the energy beam is a laser beam.

19. The method according to claim 11, comprising:
joining, after the pretreating the surface, the workpiece to at least one further component by connecting the workpiece to the at least one further component via the pretreated surface.

20. The method according to claim 19, wherein the connecting comprises adhesively bonding the workpiece to the at least one further component via the pretreated surface.

21. A pretreatment system for a surface of a workpiece, comprising:
a radiation emitter configured to radiate a beam of electromagnetic radiation onto the surface;
a detector configured to capture the electromagnetic radiation and provide an electrical signal characterizing the captured electromagnetic radiation; and
a monitor configured to evaluate the electrical signal.

22. The pretreatment system of claim 21, further comprising:
a playback device configured to output a warning signal in response to a deviation of an actual signal from a target signal exceeding a threshold value, wherein the actual signal comprises the electrical signal or at least one evaluation signal generated form the electrical signal.

23. The pretreatment system of claim 21, wherein the detector is configured to: capture and at least temporarily store the electromagnetic radiation at a frequency of at least 10 kHz.

24. The pretreatment system of claim 21, wherein the radiation emitter is configured to radiate the beam of electromagnetic radiation in a pulsed manner.

25. The pretreatment system of claim 24, wherein the radiation emitter is configured to radiate the electromagnetic radiation in the pulsed manner at a frequency of at least 1 kHz.

26. The pretreatment system of claim 21, wherein the detector comprises:
a first sensor configured to capture the electromagnetic radiation in a first wavelength range; and
a second sensor configured to capture the electromagnetic radiation in a second wavelength range, the second wavelength range at least partially differing from the first wavelength range.

27. The pretreatment system of claim 21, wherein the beam is a laser beam.
